(19) United States
(12) Patent Application Publication
(10) Pub. No.: US 2009/0274596 A1
(43) Pub. Date: Nov. 5, 2009

(54) METHOD AND APPARATUS FOR PROCESSING SILICON PARTICLES

(75) Inventors: Katsumi Takahashi, Tokyo (JP); Masaya Tanaka, Tokyo (JP); Hiroyuki Saito, Tokyo (JP); Haruyuki Kinami, Tokyo (JP); Takeshi Sasaki, Miyagi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: IHI COMPRESSOR AND MACHINERY CO., LTD., Chuo-ku (JP); M. SETEK CO., LTD., Taito-ku (JP)

(21) Appl. No.: 12/280,169

(22) PCT Filed: Apr. 25, 2006
(86) PCT No.: PCT/JP2006/308613

§ 371 Date: Jan. 15, 2009

(30) Foreign Application Priority Data
Feb. 24, 2006 (JP) 2006-048905

(51) Int. Cl. B01D 15/00; C01B 33/02

(52) U.S. Cl. 422/267; 423/349

(57) ABSTRACT

Silicon particles in waste liquid can be highly efficiently separated with inexpensive equipment to be reused as raw material for production of a single-crystal silicon ingot.

Provided are a recovery unit 12 for recovering the silicon particles from silicon-particle-containing waste liquid from a silicon ingot processing unit; a liquid mixture tank 1 for storing dissolved liquid mixture in which impurities is dissolved by mixing of the silicon particles unit with an acid; a filter-cloth-type filter 2 connected to the liquid mixture tank 1 through supply and return channels 8 and 10 for formation of cake of the silicon particles on the filter cloth for filtration; pure-water supply means 49 for supplying pure water to the liquid mixture tank 1; and pressurized air supply means 34 capable of switching between an operation for supplying pressurized air to a filtering surface side of the filter cloth to dehydrate the cake of the silicon particles and an operation for supplying the pressurized air to a side opposite to the filtering surface side of the filter cloth to drop and take out the dehydrated cake. Thus, single-crystal silicon particles free from the impurities are separated and recovered highly efficiently.

### TECHNICAL FIELD

The present invention relates to a method and an apparatus for processing silicon particles in waste liquid discharged from a silicon ingot processing unit.

### BACKGROUND ART

Conventionally, a silicon wafer used for, for example, a solar cell is manufactured such that a high-purity single-crystal silicon ingot produced cylindrically through pull-up by a single-crystal silicon ingot production unit is processed by a silicon ingot processing unit into a single-crystal silicon block through, for example, surface peeling, cutoff into required shape such as square rod and surface cutting and polishing. The produced silicon block is supplied to a separate, silicon wafer production unit where the silicon block is sliced into a predetermined thickness, using for example a wire saw.

In the above-mentioned silicon ingot processing unit for production of a silicon block from single-crystal silicon ingot, the ingot is usually processed with a large amount of water supplied for cooling so that a large amount of waste liquid containing single-crystal silicon particulates (silicon particles) as abatements is discharged from the processing unit. Conventionally, the silicon particles in the waste liquid are separated by a required method and most of the separated silicon particles are disposed of as industrial waste.

Thus, considerable amount of silicon particles are produced in production of a silicon block from single-crystal silicon ingot in a silicon ingot processing unit when the silicon block is produced from the silicon ingot. Conventionally, such expensive high-purity single-crystal silicon particles are disposed of as mere cutting loss.

It has been proposed that abatements of high-purity silicon resulting from slicing with a wire saw or a water jet are washed with an acid and dried to be supplied together with hydrogen to a plasma jet which is sprayed on a water-cooled copper target to produce a cooled lump which in turn is recovered and reused as high-purity silicon (see, for example, Reference 1).

[Reference 1] JP10-182124A

### SUMMARY OF THE INVENTION

### Problems to be Solved by the Invention

According to Reference 1, solid abatements are concentrated and recovered as slurry from machining waste liquid by, for example, a centrifugal separator or a precipitation sedimentation tank and the recovered slurry is dried. However, the abatements produced upon slicing by the wire saw or the water jet are minute particles, so that the silicon particles are recovered by the centrifugal separator or the sedimentation tank in a slurry (muddy) state containing a high percentage of water.

To separate and recover single-crystal silicon particles from the slurry without impurities is required in order to, for example, recover silicon particles resulting from production of a silicon block through machining of single-crystal silicon ingot to reuse the recovered silicon particles as raw material for production of a single-crystal silicon ingot. However, conventionally, there has been established no effective method of separating minute silicon particles in dry state from the slurry. Further, there has been established no technology for effective separation and recovery of single-crystal silicon particles free of impurities. Thus, it has not been realized to reuse silicon particles recovered from slurry as raw material for production of a single-crystal silicon block.

The invention was made in view of the above problems and has its object to provide a method and an apparatus for processing silicon particles which can separate silicon particles in waste liquid from a silicon ingot processing unit without impurities with inexpensive equipment cost to reuse the separated silicon particles as raw material for production of a single-crystal silicon ingot.

### Means or Measures for Solving the Problems

The invention relates to a method for processing silicon particles which comprises:

providing recovery means for recovering the silicon particles from discharged silicon-particle-containing waste liquid when a silicon block is formed by machining a single-crystal silicon ingot with a silicon ingot processing unit, a liquid mixture tank for storing a dissolved liquid mixture in which impurities are dissolved through mixing of the slurry-like silicon particles recovered from the recovery means with an acid and a filter-cloth-type filter for receiving the dissolved liquid mixture from the liquid mixture tank for filtration;

first, supplying the dissolved liquid mixture in the liquid mixture tank to the filter-cloth-type filter to start filtration, resultant filtrate being returned to the liquid mixture tank for circulation;

conducting the filtration while resultant filtrate is caused to flow through a discharge channel without returning the filtrate to the liquid mixture tank when cake with a required thickness is formed on filter cloth of the filter;

supplying pressurized air to a filtering surface side of the filter cloth in the filter to dehydrate the cake on the filter cloth upon completion of the filtration of the dissolved liquid mixture;

subsequently, supplying pure water to the liquid mixture tank and supplying the pure water in said tank to the filter-cloth-type filter to wash the cake on the filter cloth;

then, supplying pressurized air to the filtering surface side of the filter cloth in the filter to dehydrate the cake on the filter cloth; and

then, supplying the pressurized air to a side opposite to the filtering surface side of the filter cloth in the filter to drop the cake from the filter cloth to thereby obtain single-crystal silicon particles.

The invention further relates to a method for processing silicon particles which comprises:

providing recovery means for recovering the silicon particles from discharged silicon-particle-containing waste liquid when a silicon block is formed by machining a single-crystal silicon ingot with a silicon ingot processing unit, a liquid mixture tank for storing a dissolved liquid mixture in which impurities are dissolved through mixing of the slurry-like silicon particles recovered from the recovery means with an acid and a filter-cloth-type filter for receiving the dissolved liquid mixture from the liquid mixture tank for filtration;

first, supplying the dissolved liquid mixture in the liquid mixture tank to the filter-cloth-type filter to start the filtration, resultant filtrate being returned to the liquid mixture tank for circulation;

conducting filtration while resultant filtrate is caused to flow through a discharge channel without returning the filtrate to the liquid mixture tank when cake with a required thickness is formed on the filter cloth of the filter;

supplying pressurized air to a filtering surface side of the filter cloth in the filter to dehydrate the cake on the filter cloth upon completion of the filtration of the dissolved liquid mixture;

subsequently, supplying pure water to a side opposite to the filtering surface side of the filter cloth in the filter for backwashing to supply, to the liquid mixture tank, pure water liquid mixture of the pure water with silicon particles of the cake;

then, supplying the pure water liquid mixture in the liquid mixture tank to the filter-cloth-type filter to start filtration and washing, resultant filtrate being returned to the liquid mixture tank for circulation;

conducting the filtration while resultant filtrate is caused to flow through the discharge channel without returning the filtrate to the liquid mixture tank when cake having a required thickness is formed on the filter cloth in the filter;

supplying pressurized air to the filtering surface side of the filter cloth in the filter to dehydrate the cake on the filter cloth upon completion of the filtration and washing of the pure water liquid mixture; and

thereafter, supplying pressurized air to the side opposite to the filtering surface side of the filter cloth in the filter to drop the cake from the filter cloth to thereby obtain single-crystal silicon particles.

In the methods for processing the silicon particles described above, it is preferable that the single-crystal silicon particles taken out from the filter-cloth-type filter are dried and used as raw material for producing a single-crystal silicon ingot.

In the methods for processing the silicon particles described above, it is preferable that the liquid mixture in the liquid mixture tank is supplied to the filter-cloth-type filter for filtration while silicon particles to be processed next and the acid are supplied to and for mixing in an impurity dissolving tank to provide dissolved liquid mixture with impurities being dissolved.

In the methods for processing the silicon particles described above, it is preferable that the filtrate caused to flow through the discharge channel, after formation of the cake with the required thickness on the filter cloth through supply of the dissolved liquid mixture to the filter, is recovered by an acid recovery tank.

In the methods for processing the silicon particles described above, it is preferable that the filtrate caused to flow through the discharge channel upon supply of the pure water to the filter-cloth-type filter is recovered by a water purifying unit.

In the methods for processing the silicon particles described above, it is preferable that the filtrate caused to flow through the discharge channel after formation of the cake with the required thickness on the fiber cloth through supply of the pure water liquid mixture to the filter-cloth-type filter is recovered by a water purifying unit.

The invention further relates to an apparatus for processing the silicon particles which comprises:

a recovery unit for recovering the silicon particles from silicon-particle-containing waste liquid discharged from a silicon ingot processing unit;

a liquid mixture tank for storing dissolved liquid mixture in which impurities is dissolved by mixing of slurry-like silicon particles recovered by the recovery unit with an acid;

a filter-cloth-type filter connected to the liquid mixture tank through supply and return channels for formation of cake of the silicon particles on the filter cloth for filtration;

a discharge channel connected to the return channel for causing the filtrate to flow downstream;

pure-water supply means for supplying pure water to the liquid mixture tank; and

pressurized air supply means capable of switching between an operation for supplying pressurized air to a filtering surface side of filter cloth to dehydrate the cake of the silicon particles and an operation for supplying the pressurized air to a side opposite to the filtering surface side of the filter cloth to drop and take out the dehydrated cake.

In the apparatus for processing the silicon particles described above, preferably a drying unit is provided for drying the silicon particles taken out from the filter-cloth-type filter.

In the apparatus for processing the silicon particles described above, preferably pure-water backwashing means is provided for supplying the pure water to the side opposite to the filtering surface side of the filter cloth in the filter.

In the apparatus for processing the silicon particles described above, preferably an impurity dissolving tank is provided for producing the dissolved liquid mixture in which impurities are dissolved by mixing of the silicon particles with the acid and for supplying the dissolved liquid mixture to the liquid mixture tank.

In the apparatus for processing the silicon particles described above, preferably an acid recovery tank is connected to the discharge channel through switch means.

In the apparatus for processing the silicon particles described above, preferably a water purifying unit is connected to the discharge channel through switch means.

### EFFECTS OF THE INVENTION

According to the methods and the apparatus of the invention for processing the silicon particles, impurities are dissolved by mixing of silicon particles recovered from waste liquid from a silicon ingot processing unit with an acid, so that fluidity of the silicon particles contained in the dissolved liquid mixture can be enhanced. Thus, advantageously, filtration performance upon supply of the dissolved liquid mixture to a filter-cloth-type filter for filtration can be enhanced to prolong a service life of filter cloth.

Further, cake formed on the filter cloth through filtration of the dissolved liquid mixture in which the impurities are dissolved with the acid is washed with pure water or washed and filtered with pure water to wash and remove the acid and the dissolved impurities, so that advantageously high-purity single-crystal silicon particles free of impurities can be separated and recovered.

Thus, advantageously, the single-crystal silicon particles obtained as described above can be reused as raw material for producing a single-crystal silicon ingot, so that raw material for production of the single-crystal silicon ingot which tends to be short of supply can be stably supplied at low price while an amount of industrial waste produced can be reduced.

Further, the silicon particles washed with the pure water are easy to be dehydrated, so that the silicon particles with reduced moisture content can be taken out. Thus, advantageously, time and cost required for drying the silicon particles by a drying unit can be reduced.

Further, advantageously, separation using the filter-cloth-type filter is suitable for taking out the silicon particles with the reduced moisture content.

### BRIEF DESCRIPTION OF THE DRAWINGS

FIG. 1 is an entire schematic view showing an embodiment of an apparatus for processing silicon particles according to the invention;

FIG. 2 is a cross-sectional view showing a filtering portion in a filter-cloth-type filter;

FIG. 3 is an operational step diagram showing a first operating method;

FIG. 4 is an operational step diagram showing a second operating method; and

FIG. 5 is an entire schematic view showing a further embodiment of an apparatus for processing silicon particles according to the invention.

### EXPLANATION OF THE REFERENCE NUMERALS

1 liquid mixture tank
2 filter-cloth-type filter
7 circulation channel
8 supply channel
10 return channel
11 discharge channel
12 recovery unit (recovery means)
23 filter cloth
28 pure-water backwashing means
34 pressurized air supply means
36, 37 switch means
38 acid recovery tank
39, 40 switch means
41 water purifying unit
46 acid supply means
49 pure-water supply means
51 silicon particles (single-crystal silicon particles)
52 drying unit
53 single-crystal silicon ingot production unit
54 silicon ingot processing unit
55 impurity dissolution tank

### BEST MODE FOR CARRYING OUT THE INVENTION

Embodiments of the invention will be described with reference to the accompanying drawings.

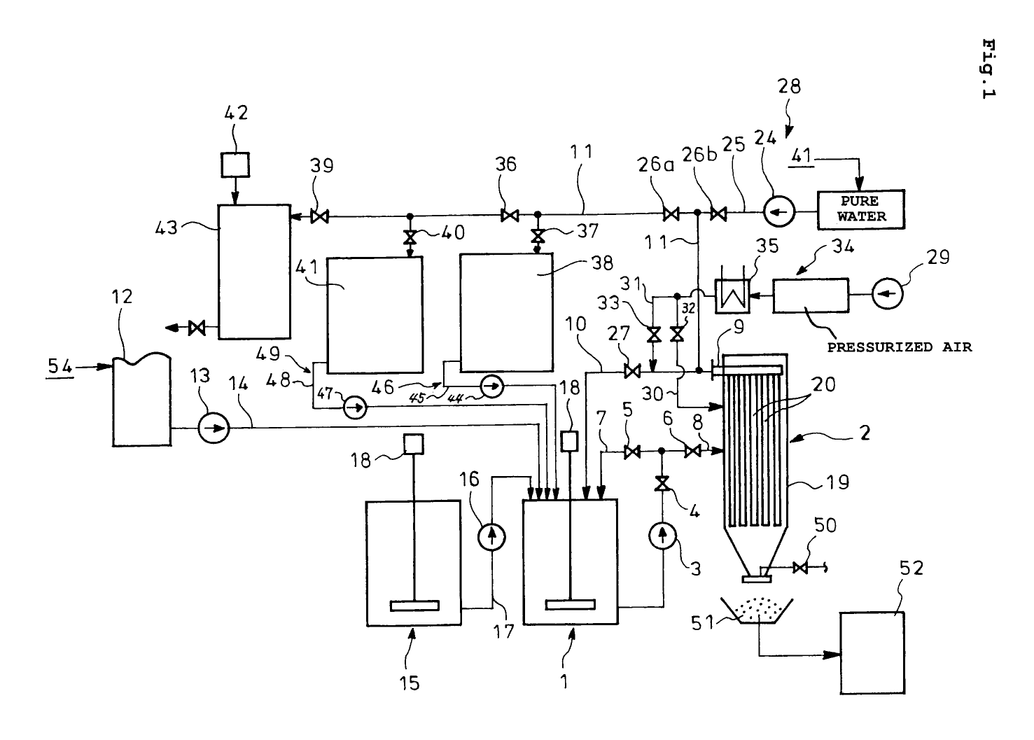

FIG. 1 is an entire schematic view showing an embodiment of an apparatus for processing silicon particles according to the invention. In FIG. 1, reference numeral 1 denotes a liquid mixture tank; and 2, a filter-cloth-type filter into which the liquid mixture from the tank 1 is introduced for filtration. The liquid mixture tank 1 is connected to the filter-cloth-type filter 2 through circulation and supply channels 7 and 8 including a pump 3 and switch means 4, 5 and 6 so that the liquid mixture from the pump 3 is circulated to the tank 1 through the channel 7 and is supplied to the filter 2 through the channel 8. In addition, a return channel 10 is connected between the liquid mixture tank 1 and a filtrate outlet pipe 9 through which filtrate flows out from the filter 2 so that the filtrate from the filter 2 may be circulated to the tank 1. A discharge channel 11 that guides the filtrate downstream is connected to an intermediate position of the return channel 10.

In FIG. 1, reference numeral 12 denotes a recovery unit (recovery means) which filtrates silicon-particle-containing waste liquid from a silicon ingot processing unit 54 to recover silicon particles. Employable as this recovery unit 12 is conventionally used various separation device such as a filter, a centrifugal separator or a precipitation sedimentation tank. Taken out from the recovery unit 12 are slurry-like silicon particles with reduced water content.

The tank 1 is supplied with the slurry-like silicon particles from the recovery unit 12 through a pump 13 and a particle supply pipe 14 and with an acid from an acid producing tank 15 through a pump 16 and an acid channel 17 for mixing with the silicon particles. Thus, carbon contained in the slurry-like silicon particles supplied to the tank 1 and Fe, Ni and the like due to wear of machining instruments are dissolved by the acid and a dissolved liquid mixture of the silicon particles with the dissolved liquid is stored in the tank 1. Each of the tanks 1 and 15 is provided with a stirring device 18 for stirring and mixing.

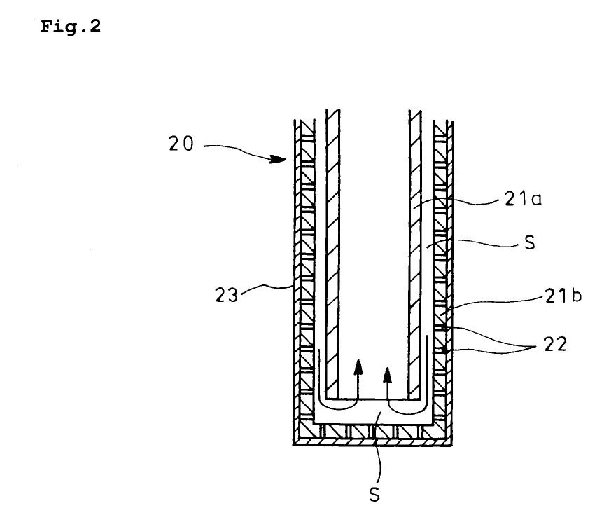

As shown in FIG. 1, the filter 2 comprises a sealed container 19 having therein the plural filtrate outlet pipes 9 penetrating through an upper portion of the container 19 and a plurality of filtering portions 20 connected at their upper ends to the pipes 9, respectively. As shown in FIG. 2, the filtering portion 20 comprises an inner pipe 21a with an upper end connected to the filtrate outlet pipe 9 and an open lower end, and an outer pipe 21b fixed to the inner pipe 21a to surround an outer circumference and a bottom of the inner pipe 21a with a gap S. The outer pipe 21b is formed with small slots 22 or is made from porous material for easy passage of liquid through the pipe 21b. The outer pipe 21b is surrounded at its outer circumference and bottom by filter cloth 23. Supply of the liquid mixture to the container 19 of the filter-cloth-type filter 2 causes the filter cloth 23 to adhere to the outer pipe 21b along the contour of the same by a pressure of the liquid mixture supplied; the filtrate passes through the filter cloth 23 with cake formed on an outer surface (filtering surface) of the filter cloth 23, thereby performing filtration (cake filtration), the filtrate descending through the gap S to flow through a lower opening of the pipe 21a into the inner pipe 21a and then through the filtrate outlet pipe 9 into the return channel 10.

Connected to the return channel 10 is the discharge channel 11 which in turn is connected to a pure water pipe 25 with a pump 24 and is provided with switch means 26a, 26b and 27, thereby constituting pure-water backwashing means 28. The backwashing means 28 serves for backwashing of the filter cloth 23 by feeding pure water to the filtrate outlet pipes 9 and thus to an inner surface side (opposite to filtering surface side) of the filter cloth 23.

Meanwhile, pressurized air supply means 34 is adapted to be switched by switch means 32 and 33 between an operation of supplying pressurized air from a fan 29 through an air pipe 30 to the container 19 and thus to the outer surface (filtering surface) side of the filter cloth 23, thereby dehydrating the silicon particles formed as cake on the filtering surface of the filter cloth 23, and an operation of supplying the pressurized air through an air pipe 31 to the inner surface side (opposite to the filtering surface side) of the filter cloth 23 to take out the dehydrated particles 51. In FIG. 1, reference numeral 35 denotes a heater for heating the pressurized air.

Provided in the discharge channel 11 is an acid recovery tank 38 to take out and recover the filtrate flowing through the discharge channel 11 by switching switch means 36 and 37.

Further provided in the discharge channel 11 is a water purifying unit 41 to take out and recover the filtrate flowing through the discharge channel 11 by switching switch means 39 and 40.

Further provided in the discharge channel 11 is a pH adjusting tank 43 comprising a pH adjuster 42 for discharging, to natural world, the filtrate which has not been recovered by the tank 38 and the purifying unit 41.

The filtrate with the acid recovered by the tank 38 is supplied to the liquid mixture tank 1 through acid supply means 46 constituted by a pump 44 and a pipe 45. In the purifying unit 41, pure water is produced by purifying the recovered filtrate. The resultant pure water is supplied to the liquid mixture tank 1 through pure water supply means 49 constituted by a pump 47 and a pipe 48. Alternatively, the pure water produced by the purifying unit 41 may be supplied to the pure-water backwashing means 28. In FIG. 1, reference numeral 50 denotes a drain outlet provided for the filter 2.

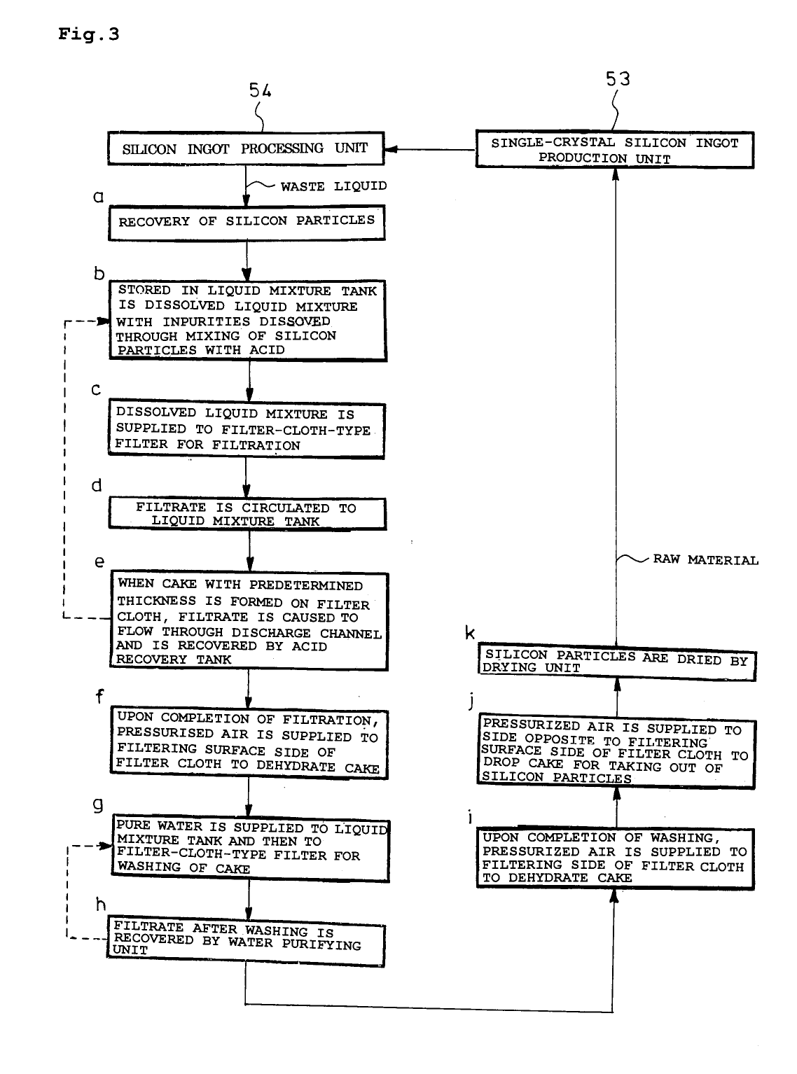

Next, a first operating method according to the above embodiment of the invention will be described with reference to FIGS. 1 and 2 and an operational step diagram of FIG. 3.

Silicon particles are recovered by the recovery unit of FIG. 1 from the waste liquid from the processing unit 54 of FIG. 3 (step a). Employable as the recovery unit 12 for recovery of the silicon particles from the waste liquid is conventional various device such as a centrifugal separator or a sedimentation precipitation tank; recovered from the recovery unit 12 are slurry-like silicon particles.

The slurry-like silicon particles recovered by the recovery unit 12 are supplied through the pump 13 and the supply pipe 14 to the tank 1 while the acid produced at a predetermined concentration in the tank 15 is supplied through the pump 16 and the acid channel 17 to the tank 1 for mixing with the silicon particles. Thus, impurities in the slurry-like silicon particles are dissolved by the acid. Here, if the filtrate with the acid recovered by the tank 38 is supplied through the supply means 46 to the tank 1, a consumption of the acid can be reduced and an amount of the waste liquid discharged from the tank 43 to nature world can be reduced (step b).

The dissolved liquid mixture stored in the liquid mixture tank 1 is supplied to the filter 2 to start the filtration (step c). Here, the switch means 27 is opened and the switch means 26a and 26b are fully closed to circulate the filtrate through the return channel 10 back to the liquid mixture tank 1 (step d).

Cake is formed on the filter cloth 23 of the filter 2 by the filtration performed, which facilitates the filtration (cake filtration). When the filtrate from the outlet pipes 9 becomes clear water containing no slurry particles, the filtration is conducted with the filtrate being caused to flow through the discharge channel 11 by opening the switch means 26a and fully closing the switch means 26b and 27. The filtrate flowing through the discharge channel 11 is recovered by the tank 38 (step e).

Upon completion of the filtration of the dissolved liquid mixture, by opening the switch means 32 of the pressurized air supply means 34 and fully closing the switch means 33, the pressurized air is supplied to the outer surface (filtering surface) side of the filter cloth in the filter 2 to dehydrate the cake on the filter cloth (step f). Here, the filtrate in the filtering portions 20 is urged by the pressurized air to flow through the outlet pipes 9 into the discharge channel 11 and the fluid in the container 19 is discharged via the drain outlet 50 to outside. Since the pressurized air for performing the dehydration is heated by the heater 35, the dissolved liquid in the cake is effectively dehydrated by the heated pressurized air.

Subsequently, the pure water in the water purifying unit 41 is supplied through the pump 47 and the pipe 48 of the supply means 49 to the tank 1 and then the pure water in the tank 1 is supplied through the supply channel 8 to the filter 2 by the pump 3 to wash the cake on the filter cloth 23 (step g). The resultant filtrate during the washing is caused to flow through the discharge channel 11 and is recovered by the purifying unit 41 (step h).

Upon completion of the washing, by opening the switch means 32 and fully closing the switch means 33 for the supply means 34, the pressurized air is supplied to the outer surface (filtering surface) side of the filter cloth 23 in the filter 2 to dehydrate the cake on the filter cloth (step i). Here, the filtrate in the filtering portion 20 is urged by the pressurized air to flow through the filtrate outlet pipes 9 into the discharge channel 11, and the fluid in the container 19 is discharged via the drain outlet 50 to outside.

Here, since the pressurized air is heated by the heater 35, the pure water contained in the cake is effectively dehydrated by the heated pressurized air. Thus, moisture contained in the cake-like silicon particles is reduced to about 40% or less.

Then, by opening the switch means 33 and fully closing the switch means 32 for the pressurized air supply means 34, the pressurized air is supplied to the inner surface side (opposite to filtering surface side) of the filter cloth 23 in the filter 2 so that the filter cloth 23 is expanded outwardly to drop the cake from the filter cloth 23. Thus, dehydrated silicon particles 51 can be taken out from the filter 2 (step j).

The silicon particles 51 taken out from the filter 2 are guided to a drying unit 52 for drying the same (step k).

Because of the separation of the impurities through dissolution by the acid and the separation of the impurities and acid through washing with the pure water, the dried silicon particles 51 are taken out as high-purity single-crystal silicon particles, so that the silicon particles can be purified through a plurality of purification processes to be utilized as raw material for production in a single-crystal silicon ingot production unit 53. In this way, the silicon particles discharged upon machining of a single-crystal silicon ingot by the processing unit 54 into a silicon block may be reused as the raw material for producing a single-crystal silicon ingot. Thus, the raw material for producing a single-crystal silicon ingot which tends to be short of supply can be stably supplied at low price while an amount of industrial waste produced can be reduced.

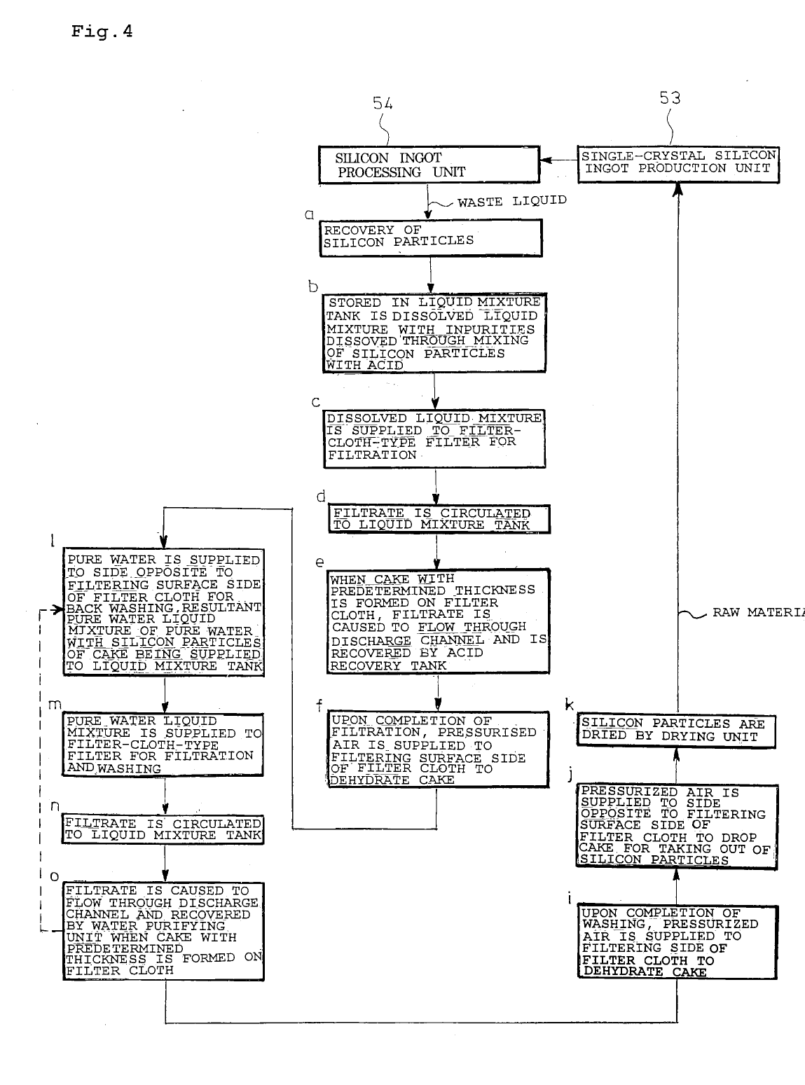

Next, a second operating method according to the above embodiment of the invention will be described with reference to FIGS. 1 and 2 and an operational step diagram of FIG. 4.

Illustrated in FIG. 4 which shows the second operating method is an operation in which steps l-o of performing washing and filtration with the pure water are substituted for step g of washing the cake with the pure water and step h of recovering the filtrate upon washing by the water purifying unit in FIG. 3.

More specifically, as shown in step f, upon completion of the filtration of the dissolved liquid mixture, the pressurized air is supplied to the filtering surface side of the filter cloth 23 in the filter 2 to dehydrate the cake. Then, as shown in step l, with the switch means 26b being opened and the switch means 26a and being fully closed, the pure water is supplied to the inner surface side (opposite to the filtering surface side) of the filter cloth 23 in the filter 2 by the pure-water backwashing means 28 to wash out the cake through backwashing. A resultant pure water liquid mixture of the pure water with the silicon particles of the cake is supplied to the liquid mixture tank 1.

Then, as shown in step m, the pure water liquid mixture in the liquid mixture tank 1 is supplied to the filter 2 to start the filtration and washing. The resultant filtrate is returned to the liquid mixture tank 1 for circulation as shown in step n.

Then, as shown in step o, the filtration is conducted with the filtrate being caused to flow through the discharge channel 11 without returning the same to the liquid mixture tank 1 when the cake with a required thickness is formed on the filter cloth 23 in the filter 2. The resultant filtrate is recovered by the water purifying unit 41.

Upon completion of the washing and filtration of the pure water liquid mixture, as shown in step i, the pressurized air is supplied to the outer surface (filtering surface) side of the filter cloth 23 in the filter 2 to dehydrate the cake on the filter cloth 23. In and after this step, the similar operations to those of FIG. 3 are performed to take out the dehydrated silicon particles 51 from the filter 2.

According to the second operating method described above, the cake produced on the filter cloth 23 of the filter 2 is backwashed with the pure water to produce the pure water liquid mixture of the pure water with the silicon particles, and the resultant pure water liquid mixture is again supplied to the filter 2 to perform the washing and filtration. Thus, advantageously, the removal of the impurities can be further enhanced and the single-crystal silicon particles with higher purity can be taken out in comparison with the second operating method described above.

As described above, according to the first and second operating methods, not only an excellent effect of separating and recovering the silicon particles at a high efficiency but also the following excellent effects can be obtained. That is, the silicon particles obtained by the recovery unit 12 from the waste liquid discharged from the processing unit 54 are mixed with the acid to dissolve the impurities so that linkage of the impurities to silicon atoms which is activated by cutoff upon machining is released to suppress the silicon particles from becoming a colloid form. Thus, fluidity of the silicon particles in the dissolved liquid mixture is enhanced to enhance filtration performance upon supply of the dissolved liquid mixture to the filter 2 for the filtration, which prevents the filter cloth 23 in the filter 2 from being clogged to prolong the service life of the filter cloth 23.

In addition, the cake formed on the filter cloth 23 due to the filtration is washed with the pure water by performing washing with the pure water (first operating method) or washing and filtration with the pure water (second operating method) so that the high-purity silicon particles free from the impurities can be taken out. Moreover, the silicon particles washed with the pure water are easy to be dehydrated so that the moisture contained in the silicon particles 51 can be reduced. Thus, time and cost required for supply of the silicon particles 51 to the drying unit 52 for dryness can be substantially reduced.

Conventionally, minute particles such as silicon particles in waste liquid discharged from the silicon ingot processing unit 54 have been recovered by a high-performance membrane-filtration-type filter using, for example, polymer or ceramic membrane intended for a minute colloidal disperse system. The polymer or ceramic membrane as filtration membrane has minute pores which tend to be immediately clogged with the minute silicon particles so that the filtration is performed while conducting backwashing. However, such filtration while conducting backwashing can separate silicon particles only in a condition of slurry containing a great amount of moisture and has difficulty in recovery in a dehydrated condition. Furthermore, the membrane-filtration-type filter itself is not suitable for processing a great amount of silicon particles.

By contrast, the filter-cloth-type filter 2 used for the invention performs the cake filtration by the filter cloth 23 having lager filtering pores in comparison with the membrane-filtration-type filter, so that it has a filtration amount increased in comparison with the membrane-filtration-type filter. Further, it has filtration function easily refreshable by backwashing. When the filter cloth 23 is clogged, the clogging may be easily cleared to be reused by removing the filter cloth 23 from the filter 2 to dip the same for example in a caustic soda solution for cleaning. Thus, the filter-cloth-type filter 2 can exhibit the excellent effects particularly when the silicon particles are taken out from the waste liquid discharged from the silicon ingot processing unit 54.

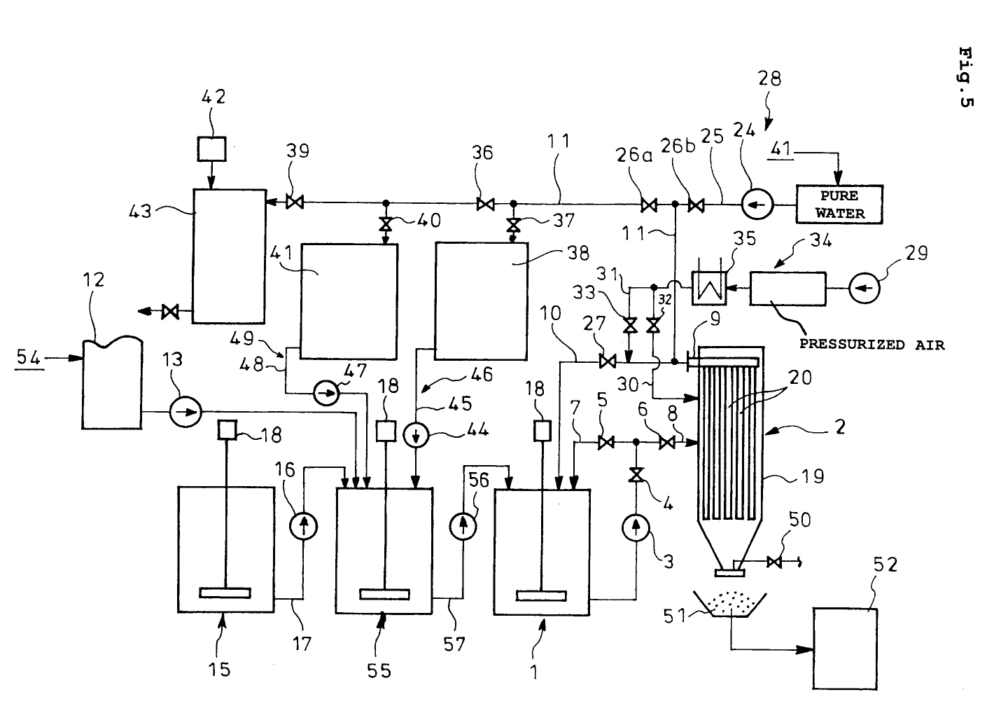

FIG. 5 is an entire schematic view showing a further embodiment of an apparatus for processing silicon particles according to the invention. In this embodiment, an impurity dissolving tank 55 is added to the embodiment of FIG. 1 described above. In this embodiment, the liquid mixture in the liquid mixture tank 1 is supplied to the filter 2 for the filtration while the silicon particles from the recovery unit 12 to be processed next and the acid from the acid generating tank 15 are supplied to the tank 55 so that the silicon particles and the acid are mixed for dissolution, the dissolved liquid mixture produced in the tank 55 being adapted to be supplied to the liquid mixture tank 1 through a pump 56 and a dissolved liquid mixture channel 57. The tank 55 is supplied with the acid in the acid recovery tank 38 through the acid supply means 46 while the pure water in the water purifying unit 41 is supplied through the pure-water supply means 49. The impurity dissolving tank 55 is also provided with the stirring device 18 to perform stirring.

According to the embodiment of FIG. 5, upon completion of the filtration operation by supply of the liquid mixture in the liquid mixture tank 1 to the filter-cloth-type filter 2, the dissolved liquid mixture generated in the tank 55 can be immediately supplied to the liquid mixture tank 1 to perform filtration for the next liquid mixture. Therefore, the operation can be efficiently performed.

It is to be noted that a method and an apparatus for processing silicon particles according to the invention are not limited to the embodiments described above and various changes and modifications may be made without departing from the scope of the invention.

1. A method for processing silicon particles which comprises:
providing recovery means for recovering the silicon particles from discharged silicon-particle-containing waste liquid when a silicon block is formed by machining a single-crystal silicon ingot with a silicon ingot processing unit, a liquid mixture tank for storing a dissolved liquid mixture in which impurities are dissolved through mixing of the slurry-like silicon particles recovered from the recovery means with an acid and a filter-cloth-type filter for receiving the dissolved liquid mixture from the liquid mixture tank for filtration;
first, supplying the dissolved liquid mixture in the liquid mixture tank to the filter-cloth-type filter to start filtration, resultant filtrate being returned to the liquid mixture tank for circulation;
conducting the filtration while resultant filtrate is caused to flow through a discharge channel without returning the filtrate to the liquid mixture tank when cake with a required thickness is formed on filter cloth of the filter;
supplying pressurized air to a filtering surface side of the filter cloth in the filter to dehydrate the cake on the filter cloth upon completion of the filtration of the dissolved liquid mixture;
subsequently, supplying pure water to the liquid mixture tank and supplying the pure water in said tank to the filter-cloth-type filter to wash the cake on the filter cloth;
then, supplying pressurized air to the filtering surface side of the filter cloth in the filter to dehydrate the cake on the filter cloth; and
then, supplying the pressurized air to a side opposite to the filtering surface side of the filter cloth in the filter to drop the cake from the filter cloth to thereby obtain single-crystal silicon particles.

2. A method for processing silicon particles which comprises:
providing recovery means for recovering the silicon particles from discharged silicon-particle-containing waste liquid when a silicon block is formed by machining a single-crystal silicon ingot with a silicon ingot processing unit, a liquid mixture tank for storing a dissolved liquid mixture in which impurities are dissolved through mixing of the slurry-like silicon particles recovered from the recovery means with an acid and a filter-cloth-type filter for receiving the dissolved liquid mixture from the liquid mixture tank for filtration;
first, supplying the dissolved liquid mixture in the liquid mixture tank to the filter-cloth-type filter to start the filtration, resultant filtrate being returned to the liquid mixture tank for circulation;
conducting filtration while resultant filtrate is caused to flow through a discharge channel without returning the filtrate to the liquid mixture tank when cake with a required thickness is formed on the filter cloth of the filter;
supplying pressurized air to a filtering surface side of the filter cloth in the filter to dehydrate the cake on the filter cloth upon completion of the filtration of the dissolved liquid mixture;
subsequently, supplying pure water to a side opposite to the filtering surface side of the filter cloth in the filter for backwashing to supply, to the liquid mixture tank, pure water liquid mixture of the pure water with silicon particles of the cake;
then, supplying the pure water liquid mixture in the liquid mixture tank to the filter-cloth-type filter to start filtration and washing, resultant filtrate being returned to the liquid mixture tank for circulation;
conducting the filtration while resultant filtrate is caused to flow through the discharge channel without returning the filtrate to the liquid mixture tank when cake having a required thickness is formed on the filter cloth in the filter;
supplying pressurized air to the filtering surface side of the filter cloth in the filter to dehydrate the cake on the filter cloth upon completion of the filtration and washing of the pure water liquid mixture; and
thereafter, supplying pressurized air to the side opposite to the filtering surface side of the filter cloth in the filter to drop the cake from the filter cloth to thereby obtain single-crystal silicon particles.

3. A method for processing silicon particles as claimed in claim 1 or 2 wherein the single-crystal silicon particles taken out from the filter-cloth-type filter are dried and used as raw material for producing a single-crystal silicon ingot.

4. A method for processing silicon particles as claimed in claim 1 or 2 wherein the liquid mixture in the liquid mixture tank is supplied to the filter-cloth-type filter for filtration while silicon particles to be processed next and the acid are supplied to and for mixing in an impurity dissolving tank to provide dissolved liquid mixture with impurities being dissolved.

5. A method for processing silicon particles as claimed in claim 1 or 2, wherein the filtrate caused to flow through the discharge channel, after formation of the cake with the required thickness on the filter cloth through supply of the dissolved liquid mixture to the filter, is recovered by an acid recovery tank.

6. A method for processing silicon particles as claimed in claim 1, wherein the filtrate caused to flow through the discharge channel upon supply of the pure water to the filter-cloth-type filter is recovered by a water purifying unit.

7. A method for processing silicon particles as claimed in claim 2, wherein the filtrate caused to flow through the discharge channel after formation of the cake with the required thickness on the fiber cloth through supply of the pure water liquid mixture to the filter-cloth-type filter is recovered by a water purifying unit.

8. An apparatus for processing silicon particles which comprises:
a recovery unit for recovering the silicon particles from silicon-particle-containing waste liquid discharged from a silicon ingot processing unit;
a liquid mixture tank for storing dissolved liquid mixture in which impurities is dissolved by mixing of slurry-like silicon particles recovered by the recovery unit with an acid;
a filter-cloth-type filter connected to the liquid mixture tank through supply and return channels for formation of cake of the silicon particles on the filter cloth for filtration;
a discharge channel connected to the return channel for causing the filtrate to flow downstream;
pure-water supply means for supplying pure water to the liquid mixture tank; and
pressurized air supply means capable of switching between an operation for supplying pressurized air to a filtering surface side of filter cloth to dehydrate the cake of the silicon particles and an operation for supplying the pressurized air to a side opposite to the filtering surface side of the filter cloth to drop and take out the dehydrated cake.

9. An apparatus for processing silicon particles as claimed in claim 8, wherein a drying unit is provided for drying the silicon particles taken out from the filter-cloth-type filter.

10. An apparatus for processing silicon particles as claimed in claim 8, wherein pure-water backwashing means is provided for supplying the pure water to the side opposite to the filtering surface side of the filter cloth in the filter.

11. An apparatus for processing silicon particles as claimed in claim 8, wherein an impurity dissolving tank is provided for producing the dissolved liquid mixture in which impurities are dissolved by mixing of the silicon particles with the acid and for supplying the dissolved liquid mixture to the liquid mixture tank.

12. An apparatus for processing silicon particles as claimed in claim 8, wherein an acid recovery tank is connected to the discharge channel through switch means.

13. An apparatus for processing silicon particles as claimed in claim 8 or 12, wherein a water purifying unit is connected to the discharge channel through switch means.
